(19) United States
(12) Patent Application Publication
(10) Pub. No.: US 2011/0126669 A1
(43) Pub. Date: Jun. 2, 2011

(54) ROTARY MECHANISM FOR MACHINE TOOL

(75) Inventors: Toshiyuki TANAKA, Saitama-shi (JP); Yoshitaka Aritomo, Utsunomiya-shi (JP); Masafumi Saito, Utsunomiya-shi (JP)

(73) Assignee: HONDA MOTOR CO., LTD., Tokyo (JP)

(21) Appl. No.: 12/953,154

(22) Filed: Nov. 23, 2010

(30) Foreign Application Priority Data
Nov. 27, 2009 (JP) 2009-269418
Sep. 24, 2010 (JP) 2010-213905

(51) Int. Cl. B23Q 16/00

(52) U.S. Cl. 74/825

(57) ABSTRACT

A rotary mechanism of a machine tool (driving device) includes a first motor for carrying out rotary driving and positioning of a workpiece support (rotary stacking-receiving die assembly), and second motors for supplementing rotation of the rotary stacking-receiving die assembly. The stop positioning accuracy of the rotary stacking-receiving die assembly due to the second motors is lower than the stop positioning accuracy of the rotary stacking-receiving die assembly due to the first motor.

### CROSS-REFERENCE TO RELATED APPLICATION

This application is based upon and claims the benefit of priority from Japanese Patent Applications No. 2009-269418 filed on Nov. 27, 2009 and No. 2010-213905 filed on Sep. 24, 2010, of which the contents are incorporated herein by reference.

### BACKGROUND OF THE INVENTION

1. Field of the Invention

The present invention relates to a rotary mechanism for rotatably driving a workpiece support, which supports a workpiece in a machine tool.

2. Description of the Related Art

A rotor core of an electric motor, for example, is constituted in a ring shape (cylindrical shape) by stacking a number of thin steel plates, which also are formed in a ring-like shape. For this purpose, each of the thin steel plates is cut out in a ring shape from a plate material, the inner peripheral portions of which are not used. Consequently, in order to improve the usage ratio of the plate material, a rotor core is adopted, which is made up from a plurality of separate core plates each formed from a fan-shaped thin steel plate, which is obtained by dividing a ring-shaped thin steel plate in a circumferential direction.

In this type of rotor core, the present inventors have proposed a manufacturing method and apparatus for the rotor core (ring core), which is formed by mutually stacking the separate core plates (see, Japanese Laid-Open Patent Publication No. 2006-223022 and International Publication No. WO 2008/065830). According to such a manufacturing method, the usage ratio for the plate material can be improved, and the time required for stacking the separate core plates can be shortened.

Incidentally, with such manufacturing apparatuses for a ring core, as disclosed in Japanese Laid-Open Patent Publication No. 2006-223022 and International Publication No. WO 2008/065830, a stacking device (punching die assembly) is provided for arranging and stacking the separate core plates in a circumferential direction. The stacking device comprises a rotary stacking-receiving die assembly (die assembly, workpiece support) that supports the separate core plates, which are stacked in a ring-like shape, and a driving device (rotary drive source) for rotating the rotary stacking-receiving die assembly through a predetermined angle (e.g., 120°). The driving device performs driving of the rotary stacking-receiving die assembly by means of a mechanism assembled from a servomotor and a belt mechanism, or by a direct drive motor. Further, driving of the rotary stacking-receiving die assembly is performed by an individual motor with respect to an individual rotary stacking-receiving die assembly.

Further, apart from the aforementioned ring core manufacturing apparatus, in a machine tool, an apparatus is known comprising a turntable (workpiece support) for supporting or mounting workpieces, and a rotating mechanism for rotatably driving the turntable (e.g., see International Publication No. WO 2007/102435). Further, in this type of rotating mechanism as well, similar to the aforementioned driving device for the rotary stacking-receiving die assembly, driving of the turntable is carried out by means of a mechanism assembled from a servomotor and a belt mechanism, or by a direct drive motor. Further, driving of the turntable is performed by an individual motor with respect to an individual turntable.

However, when driving is performed using a single motor, in addition to increasing the rotary speed of the workpiece support (rotary stacking-receiving die assembly, turntable, etc.), it is problematic to handle heavy workpieces, and it is also difficult to shorten the process operating time and be responsive to multiple types of workpieces. Further, although it might be considered to drive an individual workpiece support by means of a plurality of motors, when stop positioning of the workpiece support is performed, due to the fact that controls for relative positioning between the motors interfere with each other, there is a concern that the stop positioning accuracy may become deteriorated.

Further, during manufacturing of a rotor core from non-separate core plates, or more specifically, one which is manufactured by stacking core plates made up from thin steel plates formed in a ring-like shape, there is a case in which a method is adopted in which the ring-shaped core plates are stacked while the circumferential phase with respect to a lower layer core plate is shifted (i.e., while being rotated), with the aim of eliminating or decreasing plate thickness errors. However, also in the case of rotating ring-shaped core plates in this manner, similar to the case of rotating workpieces made up from the aforementioned separate core plates or the like, it is difficult to shorten the process operating time and be responsive to multiple types of workpieces, and further, in the case of being driven by a plurality of motors, there is a concern that the stop positioning accuracy may become deteriorated.

### SUMMARY OF THE INVENTION

The present invention, taking into consideration the above-described situations, has the object of providing a rotary mechanism for a machine tool, which is capable of improving the rotational speed of a workpiece support, and which is capable of handling a heavier workpiece, without adversely affecting positioning accuracy.

To achieve the aforementioned objects, the present invention is characterized by a rotary mechanism for a machine tool having a workpiece support that is driven rotatably, comprising a first motor and a second motor for rotatably driving the workpiece support, and wherein the stop positioning accuracy of the workpiece support due to the second motor is lower than the stop positioning accuracy of the workpiece support due to the first motor.

In accordance with the present invention constructed as described above, since the workpiece support is driven rotatably by a plurality of motors, compared to the conventional apparatus in which driving is performed by a single motor, the driving speed of the workpiece support can be improved, and also a heavier workpiece can be handled. Further, because the stop positioning accuracy of the rotary stacking-receiving die assembly by the second motor is set lower then the stop positioning accuracy of the rotary stacking-receiving die assembly by the first motor, when positioning of the rotary stacking-receiving die assembly is carried out by controlling the first motor and the second motor, positioning control by the first motor does not interfere with positioning control by the second motor, and the rotary stacking-receiving die assembly can be positioned highly accurately.

Further, in the aforementioned rotary mechanism for a machine tool, a driving force of the first motor is transmitted to the workpiece support substantially without mechanical backlash (chatter), whereas a predetermined amount of mechanical backlash is provided in a power transmission path between the second motor and the workpiece support. In the present invention, the term “mechanical backlash” shall be understood to imply a given amount of “play” that is provided intentionally.

In this manner, by intentionally providing a given amount of mechanical backlash (play) in the power transmission path between the second motor and the workpiece support, in contrast to not providing mechanical backlash in the power transmission path between the first motor and the workpiece support, with a simple structure, stop positioning accuracy of the workpiece support by the second motor can be set lower than the stop positioning accuracy of the workpiece support by the first motor. As a structure in which substantially no mechanical backlash exists in the power transmission path between the first motor and the workpiece support, the first motor may be structured as a direct drive motor, in which the workpiece support is affixed directly to the motor rotor, or a structure may be provided consisting essentially of a belt driving mechanism disposed between the first motor and the workpiece support.

Further, in the aforementioned rotary mechanism for a machine tool, a rotor of the first motor may be fixed to the workpiece support without mechanical backlash, and a gear mechanism may be disposed in the power transmission path between the second motor and the workpiece support.

In this manner, while on the one hand the first motor is constituted as a direct drive motor, by providing a gear mechanism in the power transmission path between the second motor and the workpiece support, with a simple structure, the stop positioning accuracy of the workpiece support by the second motor can be set lower than the stop positioning accuracy of the workpiece support by the first motor.

Further, in the aforementioned rotary mechanism for a machine tool, a rotor of the first motor may be fixed to the workpiece support without mechanical backlash, and a rotor of the second motor may be fixed to the workpiece support through a spline and/or a coupling.

In the foregoing manner, by utilizing a spline and/or a coupling, a given amount of mechanical backlash can be set easily.

Further, in the aforementioned rotary mechanism for a machine tool, driving forces of the first motor and the second motor may be transmitted to the workpiece support substantially without mechanical backlash, wherein the stop positioning accuracy of the second motor is lower than the stop positioning accuracy of the first motor.

In the foregoing manner, by making use of the feature that the inherent stop positioning accuracies of the first motor and the second motor are different, the stop positioning accuracy of the workpiece support by the second motor can be set lower than the stop positioning accuracy of the workpiece support by the first motor, without providing any other type of structural difference therebetween.

Further, in the aforementioned rotary mechanism for a machine tool, a first power transmission mechanism having mechanical backlash may be disposed in a power transmission path between the first motor and the workpiece support, and a second power transmission mechanism having mechanical backlash may be disposed in a power transmission path between the second motor and the workpiece support, wherein the mechanical backlash of the second power transmission mechanism is greater than the mechanical backlash of the first power transmission mechanism.

In this manner, by setting the mechanical backlash of the second power transmission mechanism to be greater than the mechanical backlash of the first power transmission mechanism, with a simple structure, the stop positioning accuracy of the workpiece support by the second motor can be set lower than the stop positioning accuracy of the workpiece support by the first motor.

Further, in the aforementioned rotary mechanism for a machine tool, a first power transmission mechanism having mechanical backlash may be disposed in a power transmission path between the first motor and the workpiece support, and a second power transmission mechanism having mechanical backlash may be disposed in a power transmission path between the second motor and the workpiece support, wherein a stop positioning accuracy of the second motor is lower than a stop positioning accuracy of the first motor.

In this manner, even in the event of mechanical backlash in both of the power transmission path between the first motor and the workpiece support and the power transmission path between the second motor and the workpiece support, by making use of the feature that the inherent stop positioning accuracies of the first motor and the second motor are different, the stop positioning accuracy of the workpiece support by the second motor can easily be set lower than the stop positioning accuracy of the workpiece support by the first motor.

Further, in the aforementioned rotary mechanism for a machine tool, the second motor may comprise a plurality of second motors.

By providing a plurality of second motors in this manner, the driving speed of the workpiece support can further be enhanced.

In accordance with the rotary mechanism for a machine tool of the present invention, without adversely affecting positioning accuracy, the rotational speed of the workpiece support can be improved, and a heavier workpiece can be handled.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view of a ring core, which is manufactured by a stacking apparatus equipped with a driving device for a rotary stacking-receiving die assembly according to an embodiment of the present invention;

FIG. 2 is a plan view with partial omission showing the structure of a stacking apparatus equipped with a driving device for a rotary stacking-receiving die assembly according to a first embodiment of the present invention;

FIG. 3A is a cross sectional view taken along line IIIA-IIIA of FIG. 2, showing an outline cross sectional view of the driving device for the rotary stacking-receiving die assembly according to the first embodiment of the present invention;

FIG. 3B is a cross sectional view taken along line IIIB-IIIB of FIG. 3A;

FIG. 4 is an outline cross sectional view showing the structure of a driving device for a rotary stacking-receiving die assembly according to a second embodiment of the present invention;

FIG. 5A is an outline cross sectional view showing the structure of a driving device for a rotary stacking-receiving die assembly according to a third embodiment of the present invention;

FIG. 5B is a cross sectional view taken along line VB-VB of FIG. 5A;

FIG. 6 is an outline cross sectional view showing the structure of a driving device for a rotary stacking-receiving die assembly according to a fourth embodiment of the present invention;

FIG. 7A is an outline cross sectional view showing the structure of a driving device for a rotary stacking-receiving die assembly according to a fifth embodiment of the present invention;

FIG. 7B is a cross sectional view taken along line VIIB-VIIB of FIG. 7A;

FIG. 8A is an outline cross sectional view showing the structure of a driving device for a rotary stacking-receiving die assembly according to a sixth embodiment of the present invention; and

FIG. 8B is a cross sectional view taken along line VIIIB-VIIIB of FIG. 8A.

### DESCRIPTION OF THE PREFERRED EMBODIMENTS

Preferred embodiments of a rotary mechanism for a machine tool according to the present invention shall be presented and described below with reference to the accompanying drawings.

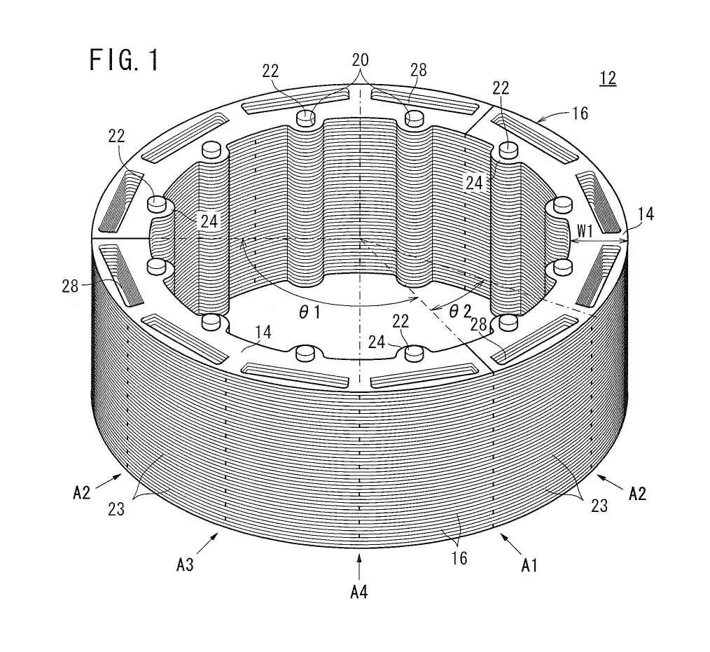

FIG. 1 is a perspective view of a ring core 12 that is manufactured by a stacking apparatus 30 equipped with a driving device for a rotary stacking-receiving die assembly (hereinafter referred to simply as “driving device”). The ring core 12 shown in FIG. 1 is constructed as a rotor core, which is one element constituting the rotor of an electric motor. A rotor is constructed by insertion of a non-illustrated rotor shaft into the hollow portion thereof, and the electric motor is constituted from the rotor thus constructed and a non-illustrated stator.

The ring core 12 is constructed by arranging a predetermined number (three in the illustrated example) of separate core plates 14 formed from thin plate fan-shaped magnetic steel sheets, at a predetermined angular separation (120° in the illustrated example) in the circumferential direction, thereby forming a ring-shaped core plate 16, and stacking a predetermined number (e.g., fifty) of the core plates 16. The number of core plates 16 may be varied appropriately responsive to usage conditions and the like.

In the ring core 12 constructed from a predetermined number of the core plates 16 in this manner, the abutment positions (abutting surfaces) of edges of the separate core plates 14 that are adjacent to each other in the circumferential direction among the separate core plates 14 of the lowermost layer (first layer) core plate 16 shown in FIG. 1, are shown by the arrow A1. In this case, the abutment positions of edges of the separate core plates 14 that are adjacent to each other in the circumferential direction among the separate core plates 14 of the layer thereabove, i.e., the second layer core plate 16, are shown by the arrows A2.

Similarly, the abutment positions of edges of the separate core plates 14 that are mutually adjacent to each other in the third layer core plate 16 are shown by the arrow A3, the abutment positions of edges of the separate core plates 14 that are mutually adjacent to each other in the fourth layer core plate 16 are shown by the arrow A4, and the abutment positions of edges of the separate core plates 14 that are mutually adjacent to each other in the fifth layer core plate 16 are shown again by the arrow A1. In layers thereabove, the core plates 16 are stacked in the same order in a similar fashion.

In this case, as can be understood from FIG. 1, the phase defined by each of the arrows A1 through A4 is shifted respectively by a predetermined angle θ2 (30° in the illustrated example). On the other hand, in each respective layer, for example in the first layer, the abutment positions of the edges are the same as the angle of the arc of one of the separate core plates 14, such that by taking the position shown by the arrow A1 as a reference, the abutment positions are situated at a total of three locations separated by 120°. A similar situation exists in each of the other layers as well.

Further, in such a ring core 12, four holes 20 are provided in each of the separate core plates 14, or in other words, twelve of such holes 20 are provided in each layer of the ring core 12. Pins 22, which are made from a non-magnetic material, are inserted into the holes 20 along the stacking direction (axial direction), thereby adjoining each of the layers together. By applying an adhesive 23 onto upper and lower surfaces of the core plates 16, the layers of the ring core 12 may be joined together more solidly.

In each of the separate core plates 14, four roughly semicircular shaped convexities (projections) 24 are formed on arcuately shaped edge portions on the inner circumferential side thereof, each of the projections 24 being arranged so as to be separated by equal intervals on the core plate 16, which is formed by arranging three of the separate core plates 14. The aforementioned holes 20 are formed substantially in the centers of such projections 24, respectively.

Furthermore, four individual magnet insertion holes 28 having rectangular shapes are formed at roughly equal intervals along the arcuately shaped edge on the outer circumferential side of the separate core plates 14. Non-illustrated magnets are inserted respectively into the magnet insertion holes 28, in a state after the separate core plates 14 have been stacked. In the illustrated embodiment, the aforementioned projections 24 are arranged respectively at the same phase position with respect to the centers of the magnet insertion holes 28.

Although the number of separate core plates 14 that constitute each of the layers of the core plates 16 is three in the illustrated embodiment, it goes without saying that the invention is not limited by this feature. If the number thereof is changed, the aforementioned angles θ1 and θ2 may simply be changed in accordance therewith. Similarly, the number of projections 24 and the number of magnet insertion holes 28 can be changed in any suitable manner.

The above-described ring core 12 is manufactured by a stacking apparatus in which the separate core plates 14 are stacked while being arranged in a ring-like shape. A driving device for rotatably driving a rotary stacking-receiving die assembly that supports the stacked separate core plates 14 is mounted in the stacking apparatus. Below, a number of embodiments of a rotary mechanism for a machine tool according to the present invention shall be described as applied examples in relation to the driving device for the rotary stacking-receiving die assembly.

### First Embodiment

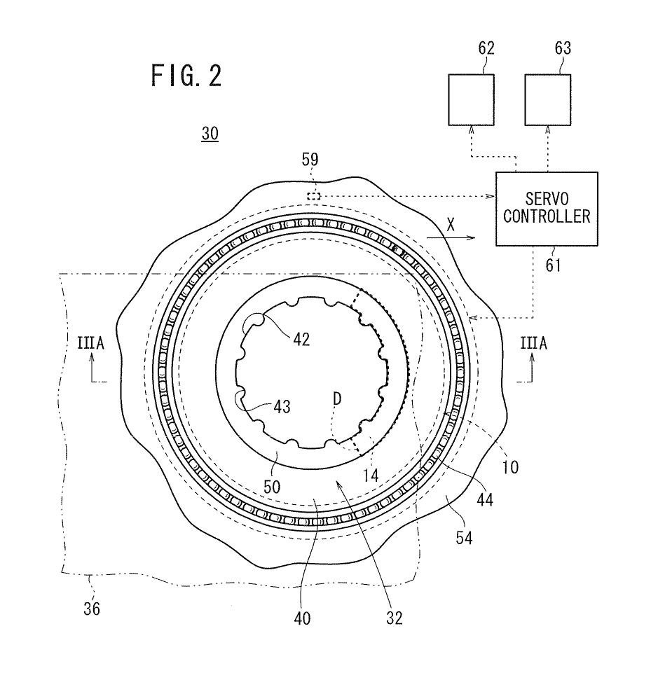

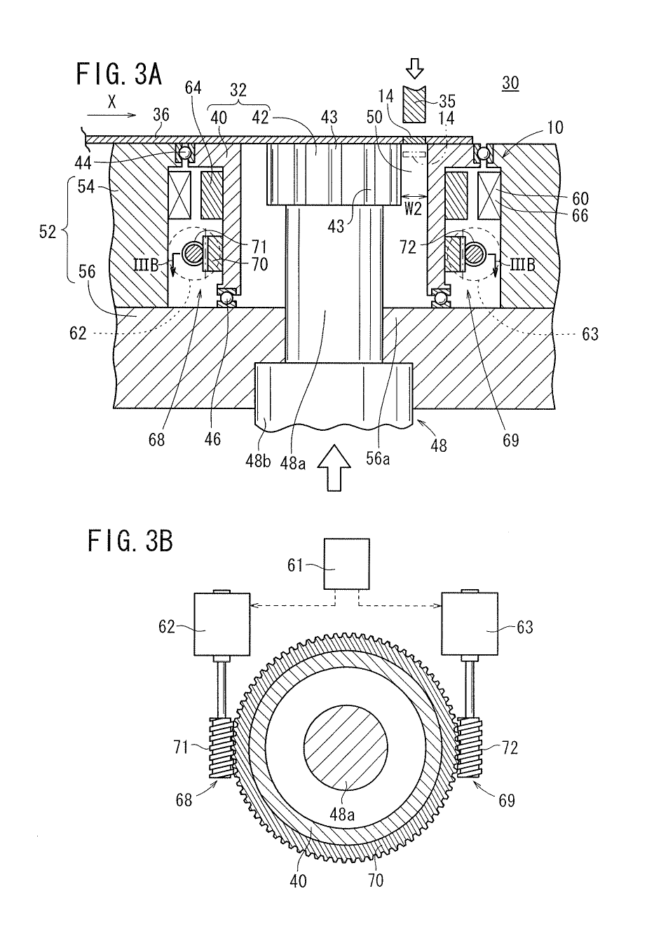

FIG. 2 is a plan view with partial omission of a stacking apparatus 30 (punching die assembly) equipped with a driving device (rotary mechanism) 10 according to a first embodiment. As shown in FIG. 2, the stacking apparatus 30 comprises a rotary stacking-receiving die assembly 32 (workpiece support, die assembly) for supporting the separate core plates 14 to be stacked, the driving device 10 for rotatably driving the rotary stacking-receiving die assembly 32, and a punch 35 (see FIG. 3A), which presses the separate core plate 14 toward the rotary stacking-receiving die assembly 32.

After the separate core plates 14 have been punched from the plate material 36, the separate core plates 14 are returned to corresponding punched portions, and are supplied to the stacking apparatus 30 in a state constituting portions of the plate material 36. In the plate material 36, the separate core plates 14, which are formed in this manner, are arranged at a predetermined pitch in the transport direction (the direction of the arrow X). While the separate core plates 14, which are supplied to the stacking apparatus 30 together with the plate material 36, are transported by the predetermined pitch in the X-direction, the separate core plates 14 are punched out (dropped) in succession from the plate material 36 at a drop (punch-out) position indicated by the reference character D in FIG. 2.

FIG. 3A is a cross sectional view taken along line IIIA-IIIA of FIG. 2, and FIG. 3B is a cross sectional view taken along line IIIB-IIIB of FIG. 3A.

The rotary stacking-receiving die assembly 32 includes an outer guide 40, which supports an outer circumferential side of the separate core plate 14 to be stacked in a ring-like shape, and an inner guide 42, which supports an inner circumferential side of the separate core plate 14 to be stacked in a ring-like shape.

The outer guide 40 is a hollow cylindrical member, which is supported rotatably in a frame 52 via bearings 44, 46. The inner guide 42 is backed up by a backpressure from a rod member 48a of a hydraulic cylinder mechanism 48, and is supported thereby at a predetermined position (height). The width W2 of an interval 50, which is formed between the outer circumferential surface of the inner guide 42 and the inner circumferential surface of the outer guide 40, is set to be slightly smaller than the width W1 (see FIG. 1) in a radial direction of the separate core plates 14, to such a degree that the separate core plate 14 can be sandwiched therebetween in a radial direction when the separate core plate 14 is pressed into the interval 50.

The frame 52 includes an upper frame section 54 that surrounds the outer guide 40 and a lower frame section 56 that is disposed downwardly from the upper frame section 54. The bearings 44 are disposed between the upper frame section 54 and a flange that is formed on the upper end of the outer guide 40, while the bearings 46 are disposed between the lower frame section 56 and the lower end of the outer guide 40.

The inner guide 42 is constructed in a substantially columnar shape, made up from an outer circumferential surface, which allows the annular edge on the inner circumferential side of the separate core plates 14 to be fitted to or separated therefrom, or stated otherwise, from an outer circumferential surface having a shape that substantially matches the annular edge. More specifically, a plurality of recesses 43 having semicircular arcuate shapes that extend in the axial direction are formed at predetermined intervals in a circumferential direction on the outer peripheral surface of the inner guide 42.

The hydraulic cylinder mechanism 48 is capable of being raised and lowered and stopped at a predetermined position, a flange 48b of which is disposed on a lower end side of a rod member 48a. The upper limit of the rod member 48a is set by abutment of the flange 48b against the flange 56a that is formed on the inner circumference of the lower frame section 56. The distal end surface (upper surface) of the rod member 48a is capable of engagement with recesses (not shown), which are disposed on the lower surface of the inner guide 42, whereby diametric positioning of the inner guide 42 is carried out.

The driving device 10 includes a first motor 60 and second motors 62, 63 for rotatably driving the rotary stacking-receiving die assembly 32. The first motor 60 primarily bears the responsibility for both rotatably driving and positioning the rotary stacking-receiving die assembly 32. The second motors 62, 63 primarily bear the responsibility for rotatably driving the rotary stacking-receiving die assembly 32.

The first motor 60 includes a rotor 64 that is attached directly to an outer circumferential part of the outer guide 40, and a stator 66 that is fixed to the upper frame section 54 so as to surround the rotor 64. More specifically, in the first embodiment, the first motor 60 is constituted as a direct drive motor, in which the rotor 64 is disposed directly on the outer circumferential side of the rotary stacking-receiving die assembly 32. Accordingly, a driving force of the first motor 60 is transmitted to the rotary stacking-receiving die assembly 32 substantially without mechanical backlash.

Further, the first motor 60 is constituted as a servomotor, in which rotational angle information and angular position (phase) information of the outer guide 40, which are detected by a sensor 59 (see FIG. 2) arranged in the vicinity of the outer guide 40, are input to a servo controller 61 (see FIG. 2), whereby the first motor 60 is subjected to a feedback control by the servo controller 61 based on the rotational angle information and the angular position information. Consequently, under the control of the servo controller 61, the outer guide 40 can be rotated to a predetermined angle with high precision.

In the first embodiment, two second motors 62, 63 are provided in the driving device 10, and gear mechanisms 68, 69 are disposed in the power transmission path between each of the two motors 62, 63 and the rotary stacking-receiving die assembly 32. The gear mechanisms 68, 69 shown in the illustrated example are constituted by worm gears. More specifically, a worm wheel 70 is affixed to the outer circumference of the rotary stacking-receiving die assembly 32, and worms 71, 72, which are fixed to output shafts of the second motors 62, 63, are enmeshed respectively with the worm wheel 70.

In this manner, by providing the gear mechanism 68, 69 in the power transmission path between each of the two motors 62, 63 and the rotary stacking-receiving die assembly 32, a given amount of mechanical chatter (backlash or play) is provided intentionally thereby. Such mechanical backlash is provided so that the stop positioning accuracy of the rotary stacking-receiving die assembly 32 by the second motors 62, 63 is made lower than the stop positioning accuracy of the rotary stacking-receiving die assembly 32 by the first motor 60. In this case, the mechanical backlash, which is provided in the power transmission path between each of the second motors 62, 63 and the rotary stacking-receiving die assembly 32, is preferably set such that the stop positioning accuracy of the rotary stacking-receiving die assembly 32 by the second motors 62, 63 is two times or more inferior than the stop positioning accuracy of the rotary stacking-receiving die assembly 32 by the first motor 60.

Further, the second motors 62, 63 also are subjected to a feedback control by the servo controller 61 based on rotational angle information and angular position (phase) information of the outer guide 40, which is detected by the sensor 59. In this case, due to the mechanical backlash possessed by the gear mechanisms 68, 69, the stop positioning accuracy of the rotary stacking-receiving die assembly 32 by the second motors 62, 63 is lower than the stop positioning accuracy of the rotary stacking-receiving die assembly 32 by the first motor 60.

The stacking apparatus 30, which is equipped with the driving device 10 according to the first embodiment, is constructed basically as described above. Next, operations and effects thereof shall be explained.

In the stacking apparatus 30, when the plate material 36 is transported from an upstream side and the first of the separate core plates 14 making up the ring core 12 is set at a drop position D (see FIG. 2) in an upper end opening of the interval 50, the punch 35 is lowered, and the first separate core plate 14 that makes up the ring core 12 is punched out from the plate material 36. At this time, because a backpressure from the hydraulic cylinder mechanism 48 is applied in order to back up the inner guide 42, the inner guide 42 is retained at a predetermined position and is not displaced by the downward pressing force from the punch 35.

The separate core plate 14, which has been punched out from the plate material 36, is pressed into the interval 50 formed between the inner guide 42 and the outer guide 40, and is retained within the interval 50 under a positioning action between the projections 24 and the recesses 43. More specifically, because the width W2 of the interval 50 between the outer circumferential surface of the inner guide 42 and the inner circumferential surface of the outer guide 40 is set to a dimension that enables the separate core plate 14 to be gripped in a radial direction when the separate core plate 14 is pressed into the interval 50, upon pressing of the separate core plate 14 into the interval 50 from the upper end opening under a pressing action of the punch 35, the inner circumferential edge portion of the separate core plate 14 is supported by the outer circumferential surface of the inner guide 42, and together therewith, the outer circumferential edge portion of the separate core plate 14 is supported by the inner circumferential surface of the outer guide 40.

Accordingly, as shown by the two-dot-dashed line in FIG. 3A, the separate core plate 14 is retained reliably within the interval 50 without falling downwardly. Further, in this case, the projections 24 of the separate core plate 14 are fittingly engaged with the recesses 43 of the inner guide 42, and by mutual engagement therebetween, the separate core plate 14 is positioned in the circumferential direction with respect to the rotary stacking-receiving die assembly 32.

In the stacking apparatus 30, when the first separate core plate 14 has been pressed into the interval 50 in the foregoing manner, next, second and subsequent separate core plates 14 are stacked in succession while being arranged in a ring-like formation inside the interval 50.

More specifically, at first, in a state where the first separate core plate 14 is retained in the interval 50, by driving the driving device 10, the outer guide 40 is rotated by a predetermined angle θ1 (120°. In this case, the separate core plate 14 is fittingly engaged between the inner guide 42 and the outer guide 40 in the radial direction as a result of being pressed therebetween, while additionally, the projections 24 of the separate core plate 14 are engaged with the recesses 43 of the inner guide 42. Owing thereto, when the outer guide 40 is rotated by the predetermined angle θ1, the separate core plate 14, which is fittingly engaged in the interval 50, and the inner guide 42 also are rotated through the predetermined angle θ1 integrally and simultaneously with the outer guide 40. Stated otherwise, when the outer guide 40 is rotated by the driving device 10, the rotary stacking-receiving die assembly 32 is rotated integrally with the separate core plate 14, which is fittingly engaged in the interval 50 of the rotary stacking receiving die assembly 32.

Thereafter, the second separate core plate 14 is press-inserted into the interval 50 from the drop position D, in the same manner as the first separate core plate 14. At this time, the second separate core plate 14 is aligned and arranged in the circumferential direction with respect to the first separate core plate 14. Additionally, after the rotary stacking-receiving die assembly 32 has been rotated again through the predetermined angle θ1 by the driving device 10, then when the third separate core plate 14 is pressed into the interval 50, the third separate core plate 14 is arranged in a ring-like shape in the same plane with the first and second separate core plates 14, and as a result, the core plate 16 making up the lowermost layer (first layer) of the ring core 12 is formed.

Concerning the second and subsequent layer core plates 16, although they basically are formed in a similar manner to formation of the first layer core plate 16, as noted above, among the separate core plates 14 of vertically adjacent core plates 16, upper layer separate core plates 14 are stacked in a state of being shifted circumferentially by the predetermined angle θ2 with respect to the lower separate layer core plates 14 therebelow. Owing thereto, in forming each layer of the core plates 16, when one layer of the core plate 16 has been formed, the core plate 16 first is rotated by the predetermined angle θ2 (30°, and then the next layer core plate 16 is formed thereabove.

The above sequence of operations is repeated thereby to stack a predetermined number of core plates 16, whereby the ring core 12 can easily and swiftly be created.

In accordance with the driving device 10 according to the first embodiment as described above, when the rotary stacking-receiving die assembly 32 is driven, in addition to rotary driving of the rotary stacking-receiving die assembly 32 by the first motor 60, because rotation of the rotary stacking-receiving die assembly 32 is supplemented also by the second motors 62, 63, compared to a case of driving by means of a single motor alone, the driving speed of the rotary stacking-receiving die assembly 32 can be improved, and in addition thereto, a heavier workpiece can be handled.

Further, as stated previously, with the driving device 10, because the stop positioning accuracy of the rotary stacking-receiving die assembly 32 by the second motors 62, 63 is set lower than the stop positioning accuracy of the rotary stacking-receiving die assembly 32 by the first motor 60, even though the rotary stacking-receiving die assembly 32 is driven by a plurality of drive sources, the stop positioning controls among the drive sources themselves do not interfere with each other. More specifically, in the case that the rotary stacking-receiving die assembly 32 is driven by a plurality of drive sources, when the stop positioning controls of the rotary stacking-receiving die assembly 32 by each of the drive sources are equivalent, stop positioning controls carried out thereby interfere mutually with each other, and as a result, it can be expected that the stop positioning accuracy of the rotary stacking-receiving die assembly 32 will be deteriorated. In contrast thereto, with the driving device 10, although a structure exists in which the rotary stacking-receiving die assembly 32 is driven by a plurality of drive sources (i.e., the first motor 60 and the second motors 62, 63), because only one first motor 60 is provided, and the stop positioning accuracy of the rotary stacking-receiving die assembly 32 by the second motors 62, 63 which make up the other rotary drive sources is set intentionally to be lower than the stop positioning accuracy of the rotary stacking-receiving die assembly 32 by the first motor 60, even though the rotary stacking-receiving die assembly 32 is driven by a plurality of drive sources, the stop positioning controls among the drive sources themselves do not interfere with each other. Owing thereto, when the rotary stacking-receiving die assembly 32 is positioned by controlling the first motor 60 and the second motors 62, 63, the stop positioning control by the first motor 60 and the stop positioning control by the second motors 62, 63 do not interfere with each other. As a result, the stop positioning accuracy of the rotary stacking-receiving die assembly 32 is dependent on the accuracy of the stop positioning control performed by the first motor 60. Accordingly, positioning of the rotary stacking-receiving die assembly 32 can be carried out with high precision.

According to the first embodiment, a structure is adopted in which mechanical backlash is not provided in the power transmission path between the first motor 60 and the rotary stacking-receiving die assembly 32, while on the other hand, a predetermined amount of mechanical backlash (play) is provided intentionally in the power transmission path between the second motors 62, 63 and the rotary stacking-receiving die assembly 32. In greater detail, by constituting the first motor 60 as a direct drive motor, a structure is provided in which the rotary drive force from the first motor 60 is transmitted, without mechanical backlash, to the rotary stacking-receiving die assembly 32, whereas in contrast thereto, by disposing the gear mechanisms 68, 69 in the power transmission path between the second motors 62, 63 and the rotary stacking-receiving die assembly 32, a certain amount of mechanical backlash is provided intentionally. The size of such mechanical backlash is selected by the size of the backlash present in the gear mechanisms 68, 69 and therefore can easily be set. With the driving device 10, worm gears are adopted as the gear mechanism 68, 69. As such worm gears, for example, if double lead worm gears are used, adjustment of backlash can easily be implemented. Because such a double lead worm gear possesses different worm teeth surfaces on left and right sides thereof, backlash can be varied arbitrarily by adjusting the relative positioning of the worm and the worm gear. Consequently, in accordance with the driving device 10, by adopting the aforementioned structure, by means of a simple structure, the stop positioning accuracy of the rotary stacking-receiving die assembly 32 by the second motors 62, 63 can be set lower than the stop positioning accuracy of the rotary stacking-receiving die assembly 32 by the first motor 60.

Furthermore, with the driving device 10 according to the first embodiment, because a plurality of second motors 62, 63 are provided, the driving speed of the rotary stacking-receiving die assembly 32 can further be improved, and also a much heavier workpiece can be handled.

Further, with the driving device 10 according to the first embodiment, because worm gears are adopted for use as the gear mechanisms 68, 69, a single worm wheel 70 can be driven by two second motors 62, 63. Owing thereto, because the second motors 62, 63 are arranged in horizontal alignment and not in the height direction, even in the case that a plurality of second motors 62, 63 are provided, a large installation space for the second motors 62, 63 in the height direction is not required. Consequently, a plurality of second motors 62, 63 can easily be disposed in the stacking apparatus 30 (die assembly).

### Second Embodiment

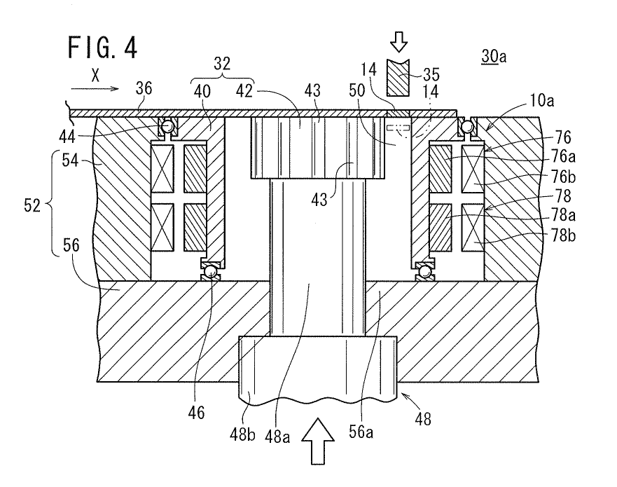

FIG. 4 is an outline cross sectional view showing the structure of a driving device (rotary mechanism) 10a for a machine tool and peripheral elements thereof according to a second embodiment of the present invention. In a stacking apparatus 30a, which is equipped with the driving device 10a according to the second embodiment, structural elements thereof, which are the same or which possess the same functions and effects of the stacking apparatus 30 equipped with the driving device 10 according to the first embodiment, are designated with the same reference characters, and detailed descriptions of such elements are omitted.

The driving device 10a according to the second embodiment comprises a first motor 76, which primarily bears the responsibility for rotatably driving and positioning of the rotary stacking-receiving die assembly 32, and a second motor 78, which primarily bears the responsibility for rotatably driving the rotary stacking-receiving die assembly 32.

The first motor 76 includes a rotor 76a that is attached directly to an outer circumferential part of the outer guide 40, and a stator 76b that is fixed to the upper frame section 54 so as to surround the rotor 76a. Further, the second motor 78 includes a rotor 78a that is attached directly to an outer circumferential part of the outer guide 40, and a stator 78b that is fixed to the upper frame section 54 so as to surround the rotor 78a. More specifically, in the second embodiment, both the first motor 76 and the second motor 78 are constituted as direct drive motors, in which the rotors 76a, 78a thereof are disposed directly on the outer circumferential side of the rotary stacking-receiving die assembly 32. Accordingly, driving forces of the first motor 76 and the second motor 78 are transmitted to the rotary stacking-receiving die assembly 32 substantially without mechanical backlash.

Further, the first motor 76 is constituted as a servomotor, in which rotational angle information and angular position (phase) information of the outer guide 40, which are detected by a sensor 59 (see FIG. 2) arranged in the vicinity of the outer guide 40, are input to a servo controller 61 (see FIG. 2), whereby the first motor 76 is subjected to a feedback control by the servo controller 61 based on the rotational angle information and the angular position information. Consequently, under the control of the servo controller 61, the outer guide 40 can be rotated by the first motor 76 to a predetermined angle with high precision.

In the second embodiment, the second motor 78, similar to the first motor 76, is constituted as a servomotor, in which rotational driving and stopping of the second motor 78 are controlled by the servo controller 61 based on rotational angle information and angular position (phase) information of the outer guide 40, which are detected by the sensor 59. However, the stop positioning accuracy of the second motor 78 is lower than the stop positioning accuracy of the first motor 76. More specifically, concerning the first motor 76, one in which the stop positioning accuracy thereof is high, is selected and installed, whereas concerning the second motor 78, one in which the stop positioning accuracy thereof is low, is selected and installed. In this case, preferably, the stop positioning accuracy of the second motor 78 is two times or more inferior than the stop positioning accuracy of the first motor 76. Stated otherwise, preferably, for the second motor 78, one is used in which the stop positioning accuracy thereof is two times or more dropped below that of the first motor 76.

The stacking apparatus 30a equipped with the driving device 10a according to the second embodiment is capable of manufacturing the ring core 12 by means of the same processing steps performed by the above-described stacking apparatus 30.

In accordance with the driving device 10a according to the second embodiment, when the rotary stacking-receiving die assembly 32 is driven, in addition to rotary driving of the rotary stacking-receiving die assembly 32 by the first motor 76, because rotation of the rotary stacking-receiving die assembly 32 is supplemented also by the second motor 78, similar to the driving device 10 according to the first embodiment, compared to a case of driving by means of a single motor alone, the driving speed of the rotary stacking-receiving die assembly 32 can be improved, and a heavier workpiece can be handled.

Further, as stated previously, with the driving device 10a, because the stop positioning accuracy of the rotary stacking-receiving die assembly 32 by the second motor 78 is set lower than the stop positioning accuracy of the rotary stacking-receiving die assembly 32 by the first motor 76, even though the rotary stacking-receiving die assembly 32 is driven by a plurality of drive sources, the stop positioning controls among the drive sources themselves do not interfere with each other, and positioning of the rotary stacking-receiving die assembly 32 can be carried out with high precision.

With the driving device 10a, by making use of differences between the inherent stop positioning accuracies of the first motor 76 and the second motor 78, the stop positioning accuracy of the rotary stacking-receiving die assembly 32 by the second motor 78 can easily be set lower than the stop positioning accuracy of the rotary stacking-receiving die assembly 32 by the first motor 76, without providing other substantial structural differences between the first and second motors 76, 78.

Further, in the second embodiment, concerning respective structural elements thereof which are common with the first embodiment, it goes without saying that the same or similar operations and effects can be obtained as the operations and effects possessed by each of such common structural elements in the first embodiment.

### Third Embodiment

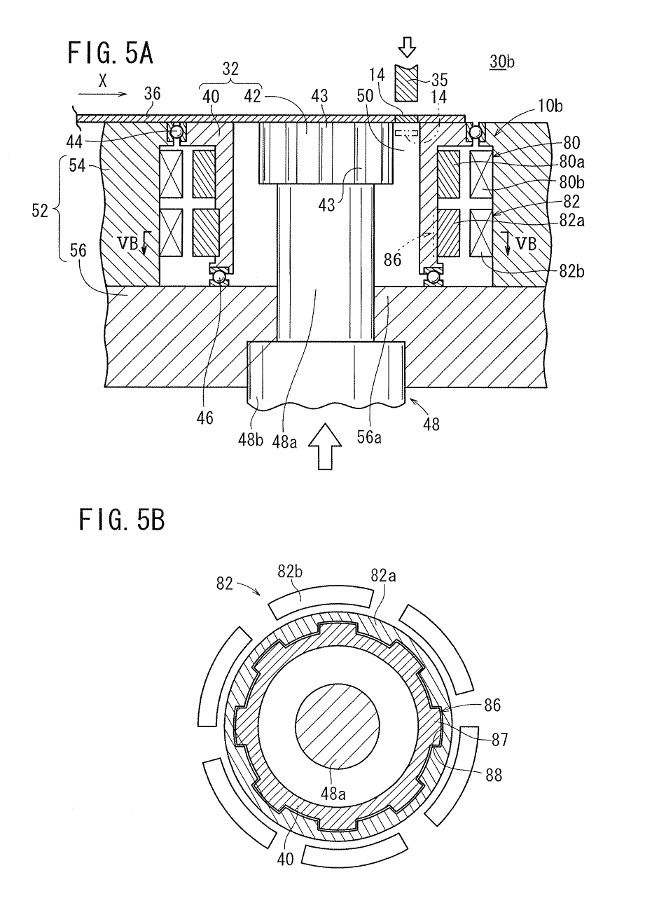

FIG. 5A is an outline cross sectional view showing the structure of a driving device (rotary mechanism) 10b for a machine tool (hereinafter also referred to simply as “driving device”) and peripheral elements thereof according to a third embodiment of the present invention. FIG. 5B is a cross sectional view taken along line VB-VB of FIG. 5A. In a stacking apparatus 30b, which is equipped with the driving device 10b according to the third embodiment, structural elements thereof, which are the same or which possess the same functions and effects of the stacking apparatus 30 equipped with the driving device 10 according to the first embodiment, are designated with the same reference characters, and detailed descriptions of such features are omitted.

The driving device 10b according to the third embodiment comprises a first motor 80, which primarily bears the responsibility for rotatably driving and positioning of the rotary stacking-receiving die assembly 32, and a second motor 82, which primarily bears the responsibility for rotatably driving the rotary stacking-receiving die assembly 32. The first motor 80 includes a rotor 80a that is attached directly to an outer circumferential part of the outer guide 40, and a stator 80b that is fixed to the upper frame section 54 so as to surround the rotor 80a. More specifically, the first motor 80 is constituted as a direct drive motor, in which the rotor 80a thereof is disposed directly on the outer circumferential side of the rotary stacking-receiving die assembly 32. Accordingly, the driving force of the first motor 80 is transmitted to the rotary stacking-receiving die assembly 32 substantially without mechanical backlash.

Further, the first motor 80 is constituted as a servomotor, in which rotational angle information and angular position (phase) information of the outer guide 40, which are detected by a sensor 59 (see FIG. 2) arranged in the vicinity of the outer guide 40, are input to a servo controller 61 (see FIG. 2), whereby the first motor 80 is subjected to a feedback control by the servo controller 61 based on the rotational angle information and the angular position information. Consequently, under the control of the servo controller 61, the outer guide 40 can be rotated by the first motor 80 to a predetermined angle with high precision.

On the other hand, the second motor 82 includes a rotor 82a that is attached, while possessing a given amount of mechanical backlash, to an outer circumferential part of the outer guide 40, and a stator 82b that is fixed to the upper frame section 54 so as to surround the rotor 82a. In the third embodiment, the aforementioned backlash is provided by means of splines 86. More specifically, as shown in FIG. 5B, a part of the rotary stacking-receiving die assembly 32 is constituted as a spline shaft, on which protruding keys 87, which extend in the axial direction, are placed at intervals in the circumferential direction. The rotor 82a is fittingly engaged at a location corresponding to a spline axis of the rotary stacking-receiving die assembly 32, and is constituted as a boss having grooves 88 therein that correspond with the keys 87. Consequently, although the second motor 82 is constructed as a direct drive motor, in which the rotor 82a is disposed directly on the outer circumferential side of the rotary stacking-receiving die assembly 32, by means of the splines 86, a given amount of mechanical backlash is provided in the power transmission path between the rotor 82a and the rotary stacking-receiving die assembly 32.

In the third embodiment, the second motor 82, similar to the first motor 80, is constituted as a servomotor, in which rotational driving and stopping of the second motor 82 are controlled by the servo controller 61 based on rotational angle information and angular position (phase) information of the outer guide 40, which are detected by the sensor 59. However, as noted above, because mechanical backlash by the splines 86 is provided in the power transmission path between the rotor 82a and the rotary stacking-receiving die assembly 32, the stop positioning accuracy of the rotary stacking-receiving die assembly 32 by the second motor 82 is lower than the stop positioning accuracy of the rotary stacking-receiving die assembly 32 by the first motor 80. In this case, preferably, the mechanical backlash provided in the power transmission path between the second motor 82 and the rotary stacking-receiving die assembly 32 is set such that the stop positioning accuracy of the rotary stacking-receiving die assembly 32 by the second motor 82 is two times or more inferior than the stop positioning accuracy of the rotary stacking-receiving die assembly 32 by the first motor 80.

The stacking apparatus 30b equipped with the driving device 10b according to the third embodiment is capable of manufacturing the ring core 12 by means of the same processing steps performed by the above-described stacking apparatus 30.

In accordance with the driving device 10b according to the third embodiment, when the rotary stacking-receiving die assembly 32 is driven, in addition to rotary driving of the rotary stacking-receiving die assembly 32 by the first motor 80, because rotation of the rotary stacking-receiving die assembly 32 is supplemented also by the second motor 82, similar to the driving device 10 according to the first embodiment, compared to a case of driving by means of a single motor alone, the driving speed of the rotary stacking-receiving die assembly 32 can be improved, and a heavier workpiece can be handled.

Further, as stated previously, with the driving device 10b, because the stop positioning accuracy of the rotary stacking-receiving die assembly 32 by the second motor 82 is set lower than the stop positioning accuracy of the rotary stacking-receiving die assembly 32 by the first motor 80, even though the rotary stacking-receiving die assembly 32 is driven by a plurality of drive sources, the stop positioning controls among the drive sources themselves do not interfere with each other, and positioning of the rotary stacking-receiving die assembly 32 can be carried out with high precision.

With the driving device 10b, although the second motor 82 is constituted as a direct drive motor, by utilizing the splines 86, mechanical backlash can easily be provided in the power transmission path between the second motor 82 and the rotary stacking-receiving die assembly 32. Accordingly, comparatively easily, the stop positioning accuracy of the rotary stacking-receiving die assembly 32 by the second motor 82 can be set lower than the stop positioning accuracy of the rotary stacking-receiving die assembly 32 by the first motor 80.

Further, in the third embodiment, concerning respective structural elements thereof which are common with the first embodiment, it is a matter of course that the same or similar operations and effects can be obtained as the operations and effects possessed by each of such common structural elements in the first embodiment.

### Fourth Embodiment

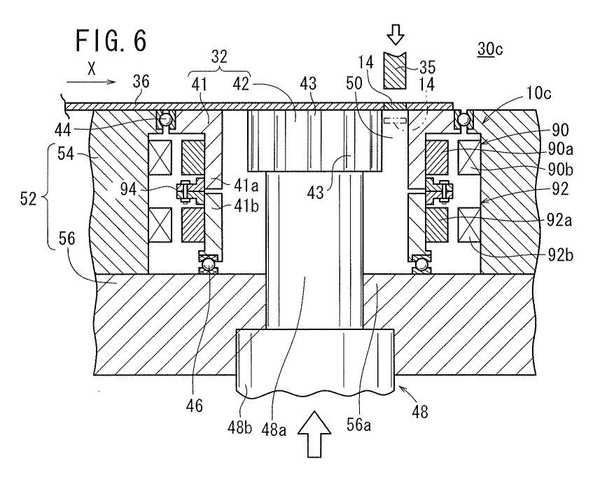

FIG. 6 is an outline cross sectional view showing the structure of a driving device (rotary mechanism) 10c for a machine tool (hereinafter also referred to simply as “driving device”) and peripheral elements thereof according to a fourth embodiment of the present invention. In a stacking apparatus 30c, which is equipped with the driving device 10c according to the fourth embodiment, structural elements thereof, which are the same or which possess the same functions and effects of the stacking apparatus 30 equipped with the driving device 10 according to the first embodiment, are designated with the same reference characters, and detailed descriptions of such features are omitted.

The driving device 10c according to the fourth embodiment comprises a first motor 90, which primarily bears the responsibility for rotatably driving and positioning of the rotary stacking-receiving die assembly 32, and a second motor 92, which primarily bears the responsibility for rotatably driving the rotary stacking-receiving die assembly 32.

In this case, the outer guide 41 includes a hollow cylindrical first member 41a to which a rotor of the first motor 90 is fixed, a hollow cylindrical second member 41b to which a rotor of the second motor 92 is fixed, and a coupling 94, which joins the first member 41a and the second member 41b. The interval 50, into which the separate core plates 14 are press-inserted, is formed between the first member 41a and the inner guide 42. The coupling 94 is formed as a flexible coupling, which is capable of permitting angular shifting in the direction of rotation within a predetermined angular range. More specifically, the first member 41a and the second member 41b are joined together mutually while having mechanical backlash around the axial centers thereof.

The first motor 90 includes a rotor 90a that is attached directly to an outer circumferential part of the first member 41a, and a stator 90b that is fixed to the upper frame section 54 so as to surround the rotor 90a. More specifically, the first motor 90 is constituted as a direct drive motor, in which the rotor 90a thereof is disposed directly on the outer circumferential side of the rotary stacking-receiving die assembly 32. Accordingly, the driving force of the first motor 90 is transmitted to the rotary stacking-receiving die assembly 32 substantially without mechanical backlash.

Further, the first motor 90 is constituted as a servomotor, in which rotational angle information and angular position (phase) information of the outer guide 41, which are detected by a sensor 59 (see FIG. 2) arranged in the vicinity of the outer guide 41, are input to a servo controller 61 (see FIG. 2), whereby the first motor 90 is subjected to a feedback control by the servo controller 61 based on the rotational angle information and the angular position information. Consequently, under the control of the servo controller 61, the outer guide 41 can be rotated by the first motor 90 to a predetermined angle with high precision.

The second motor 92 includes a rotor 92a that is attached directly to an outer circumferential part of the second member 41b, and a stator 92b that is fixed to the upper frame section 54 so as to surround the rotor 92a. More specifically, the second motor 92 is constituted as a direct drive motor, in which the rotor 92a thereof is disposed directly on the outer circumferential side of the rotary stacking-receiving die assembly 32.

In the fourth embodiment, the second motor 92 is constituted as a servomotor similar to the first motor 90, and control of rotary driving and stopping of the second motor 92 is performed by the servo controller 61 based on rotational angle information and angular position (phase) information of the outer guide 41 as detected by the sensor 59. As described above, because mechanical backlash is provided by the coupling 94 in the power transmission path between the rotor 92a of the second motor 92 and the first member 41a that makes up part of the rotary stacking-receiving die assembly 32, the stop positioning accuracy of the rotary stacking-receiving die assembly 32 by the second motor 92 is made lower than the stop positioning accuracy of the rotary stacking-receiving die assembly 32 by the first motor 90. In this case, preferably, the mechanical backlash due to the coupling 94 is set such that the stop positioning accuracy of the rotary stacking-receiving die assembly 32 by the second motor 92 is two times or more inferior than the stop positioning accuracy of the rotary stacking-receiving die assembly 32 by the first motor 90.

The stacking apparatus 30c equipped with the driving device 10c according to the fourth embodiment is capable of manufacturing the ring core 12 by means of the same processing steps performed by the above-described stacking apparatus 30.

In accordance with the driving device 10c according to the fourth embodiment, when the rotary stacking-receiving die assembly 32 is driven, in addition to rotary driving of the rotary stacking-receiving die assembly 32 by the first motor 90, because rotation of the rotary stacking-receiving die assembly 32 is supplemented also by the second motor 92, similar to the driving device 10 according to the first embodiment, compared to a case of driving by means of a single motor alone, the driving speed of the rotary stacking-receiving die assembly 32 can be improved, and a heavier workpiece can be handled.

Further, as stated previously, with the driving device 10c, because the stop positioning accuracy of the rotary stacking-receiving die assembly 32 by the second motor 92 is set lower than the stop positioning accuracy of the rotary stacking-receiving die assembly 32 by the first motor 90, even though the rotary stacking-receiving die assembly 32 is driven by a plurality of drive sources, the stop positioning controls among the drive sources themselves do not interfere with each other, and positioning of the rotary stacking-receiving die assembly 32 can be carried out with high precision.

With the driving device 10c, the second motor 92 is constituted as a direct drive motor. By utilizing the coupling 94, mechanical backlash can easily be provided in the power transmission path between the second motor 92 and the rotary stacking-receiving die assembly 32. Accordingly, comparatively easily, the stop positioning accuracy of the rotary stacking-receiving die assembly 32 by the second motor 92 can be set lower than the stop positioning accuracy of the rotary stacking-receiving die assembly 32 by the first motor 90.

Further, in the fourth embodiment, concerning respective structural elements thereof which are common with the first embodiment, it is a matter of course that the same or similar operations and effects can be obtained as the operations and effects possessed by each of such common structural elements in the first embodiment.

### Fifth Embodiment

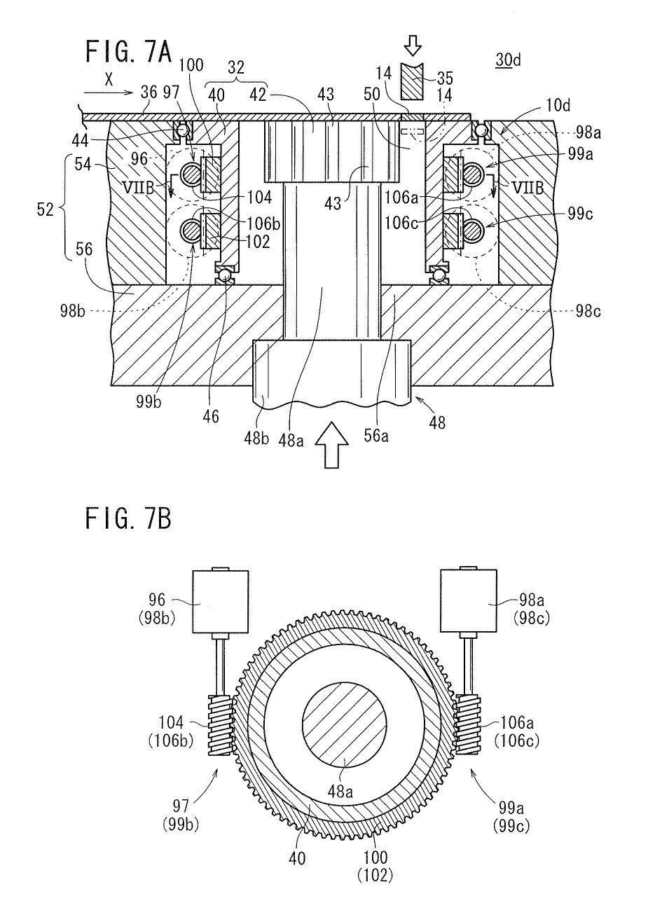

FIG. 7A is an outline cross sectional view showing the structure of a driving device (rotary mechanism) 10d for a machine tool (hereinafter also referred to simply as “driving device”) and peripheral elements thereof according to a fifth embodiment of the present invention. FIG. 7B is a cross sectional view taken along line VIIB-VIIB of FIG. 7A. In a stacking apparatus 30d, which is equipped with the driving device 10d according to the fifth embodiment, structural elements thereof, which are the same or which possess the same functions and effects of the stacking apparatus 30 equipped with the driving device 10 according to the first embodiment, are designated with the same reference characters, and detailed descriptions of such elements are omitted.

The driving device 10d according to the fifth embodiment includes a first motor 96, which primarily bears the responsibility for both rotatably driving and positioning the rotary stacking-receiving die assembly 32, and second motors 98a to 98c, which primarily bear the responsibility for rotatably driving the rotary stacking-receiving die assembly 32. In the illustrated example, three of such second motors 98a to 98c are provided.

A first power transmission mechanism 97 having mechanical backlash is disposed in a power transmission path between the first motor 96 and the rotary stacking-receiving die assembly 32. Second power transmission mechanisms 99a to 99c having mechanical backlash are disposed in power transmission paths between each of the second motors 98a to 98c and the rotary stacking-receiving die assembly 32. The first power transmission mechanism 97 and the second power transmission mechanisms 99a to 99c of the illustrated example all are constituted as worm gear mechanisms.

More specifically, a first worm wheel 100 and a second worm wheel 102 are fixed to the outer periphery of the rotary stacking-receiving die assembly 32. Worms 104, 106a, which are attached to output shafts of the first motor 96 and the second motor 98a, are enmeshed respectively with the first worm wheel 100, whereas worms 106b, 106c, which are attached to output shafts of the second motors 98b, 98c, are enmeshed respectively with the second worm wheel 102.

The above-described first power transmission mechanism 97 is constituted by the first worm wheel 100 and the worm 104 that is attached to the output shaft of the first motor 96. The above-described second power transmission mechanism 99a is constituted by the first worm wheel 100 and the worm 106a that is attached to the output shaft of the second motor 98a. Further, the above-described second power transmission mechanisms 99b, 99c are constituted respectively by the second worm wheel 102 and the worms 106b, 106c that are attached to the output shafts of the second motors 98b, 98c.

The first motor 96 and the second motors 98a to 98c are constituted as servomotors, in which rotational angle information and angular position (phase) information of the outer guide 40, which are detected by a sensor 59 (see FIG. 2) arranged in the vicinity of the outer guide 40, are input to a servo controller 61 (see FIG. 2), whereby the first motor 96 and the second motors 98a to 98c are subjected to feedback controls by the servo controller 61 based on the rotational angle information and the angular position information. In the fifth embodiment, the inherent stop positioning accuracy of the first motor 96 is substantially equivalent to the inherent stop positioning accuracies of the second motors 98a to 98c.

The backlash of the second power transmission mechanisms 99a to 99c is set to be greater than the backlash of the first power transmission mechanism 97. Owing thereto, the mechanical backlash of the second power transmission mechanisms 99a to 99c exceeds the mechanical backlash of the first power transmission mechanism 97. As a result, the actual stop positioning accuracy of the rotary stacking-receiving die assembly 32 by the second motors 98a to 98c is lower than the actual stop positioning accuracy of the rotary stacking-receiving die assembly 32 by the first motor 96.

Moreover, the backlash of the second power transmission mechanisms 99a to 99c preferably is two times or more greater than the backlash of the first power transmission mechanism 97. Owing thereto, the stop positioning accuracy of the rotary stacking-receiving die assembly 32 by the second motors 98a to 98c can be set two times or more inferior than the stop positioning accuracy of the rotary stacking-receiving die assembly 32 by the first motor 96.

The stacking apparatus 30d equipped with the driving device 10d according to the fifth embodiment is capable of manufacturing the ring core 12 by means of the same processing steps performed by the above-described stacking apparatus 30.

In accordance with the driving device 10d according to the fifth embodiment, when the rotary stacking-receiving die assembly 32 is driven, in addition to rotary driving of the rotary stacking-receiving die assembly 32 by the first motor 96, because rotation of the rotary stacking-receiving die assembly 32 is supplemented also by the second motors 98a to 98c, similar to the driving device 10 according to the first embodiment, compared to a case of driving by means of a single motor alone, the driving speed of the rotary stacking receiving die assembly 32 can be improved, and a heavier workpiece can be handled.

Further, as stated previously, with the driving device 10d, because, by setting the backlash only of the first power transmission mechanism 97 to be small insofar as possible, and by setting the backlash of the second power transmission mechanisms 99a to 99c to be large, the stop positioning accuracy of the rotary stacking-receiving die assembly 32 by the second motors 98a to 98c is set lower than the stop positioning accuracy of the rotary stacking-receiving die assembly 32 by the first motor 96, even though the rotary stacking-receiving die assembly 32 is driven by a plurality of drive sources, the stop positioning controls among the drive sources themselves do not interfere with each other, and positioning of the rotary stacking-receiving die assembly 32 can be carried out with high precision.

With the driving device 10d, by setting the mechanical chatter (backlash) of the second power transmission mechanisms 99a to 99c to be greater than the mechanical backlash of the first power transmission mechanism 97, with a simple structure, the stop positioning accuracy of the rotary stacking-receiving die assembly 32 by the second motors 98a to 98c can be set lower than the stop positioning accuracy of the rotary stacking-receiving die assembly 32 by the first motor 96.

Further, with the driving device 10d, because worm gears are adopted for use as the first power transmission mechanism 97 and the second power transmission mechanisms 99a to 99c, a plurality of motors (the first motor 96, the second motor 98a, or the second motors 98b, 98c) can be disposed with respect to a single worm wheel (the worm wheel 100 or the worm wheel 102). Owing thereto, because each of the motors is arranged in horizontal alignment and not in the height direction with respect to a single worm wheel, a large installation space in the height direction is not required. Consequently, a plurality of motors (the first motor 96, the second motor 98a, and the second motors 98b, 98c) can easily be disposed in the stacking apparatus 30 (die assembly).

Further, in the driving device 10d, the second motors 98b, 98c may be dispensed with. In such a structure as well, compared to the case of driving by a single motor, the driving speed of the rotary stacking-receiving die assembly 32 can be improved. Further, in this case, with the driving device 10d, because worm gears are adopted for use as the first power transmission mechanism 97 and the second power transmission mechanism 99a, a structure can be adopted in which the rotary stacking-receiving die assembly 32 is driven by the first motor 96 and the second motor 98a, and along therewith, because the first motor 96 and the second motor 98a are disposed in horizontal alignment with each other, compared to the first through fourth embodiments, it is possible to reduce the space in the height direction required for arrangement of the drive sources. Consequently, the size of the stacking apparatus 30 (die assembly) can be made smaller in scale.

Further, in the fifth embodiment, concerning respective structural elements thereof which are common with the first embodiment, it is a matter of course that the same or similar operations and effects can be obtained as the operations and effects possessed by each of such common structural elements in the first embodiment.

### Sixth Embodiment

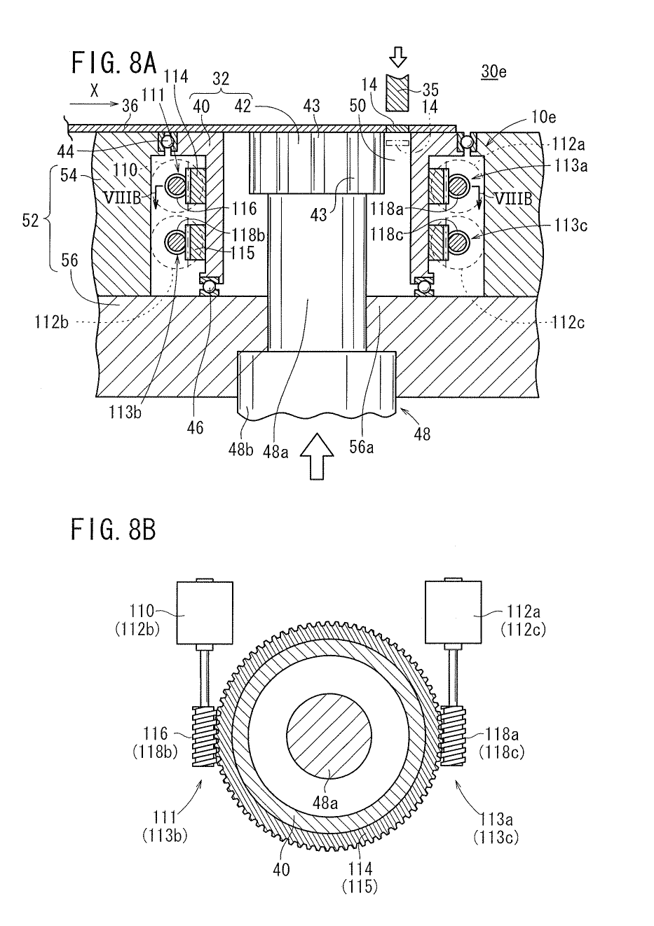

FIG. 8A is an outline cross sectional view showing the structure of a driving device (rotary mechanism) 10e for a machine tool (hereinafter also referred to simply as “driving device”) and peripheral elements thereof according to a sixth embodiment of the present invention. FIG. 8B is a cross sectional view taken along line VIIB-VIIB of FIG. 8A. In a stacking apparatus 30e, which is equipped with the driving device 10e according to the sixth embodiment, structural elements thereof, which are the same or which possess the same functions and effects of the stacking apparatus 30 equipped with the driving device 10 according to the first embodiment, are designated with the same reference characters, and detailed descriptions of such features are omitted.

The driving device 10e according to the sixth embodiment includes a first motor 110, which primarily bears the responsibility for both rotatably driving and positioning the rotary stacking-receiving die assembly 32, and second motors 112a to 112c, which primarily bear the responsibility for rotatably driving the rotary stacking-receiving die assembly 32. In the illustrated example, three of such second motors 112a to 112c are provided.

A first power transmission mechanism 111 having mechanical backlash is disposed in a power transmission path between the first motor 110 and the rotary stacking-receiving die assembly 32. Second power transmission mechanisms 113a to 113c having mechanical backlash are disposed in power transmission paths between each of the second motors 112a to 112c and the rotary stacking-receiving die assembly 32. The first power transmission mechanism 111 and the second power transmission mechanisms 113a to 113c of the illustrated example all are constituted as worm gear mechanisms.

More specifically, a first worm wheel 114 and a second worm wheel 115 are fixed to the outer periphery of the rotary stacking-receiving die assembly 32. Worms 116, 118a, which are attached to output shafts of the first motor 110 and the second motor 112a, are enmeshed respectively with the first worm wheel 114, whereas worms 118b, 118c, which are attached to output shafts of the second motors 112b, 112c, are enmeshed respectively with the second worm wheel 115.

The above-described first power transmission mechanism 111 is constituted by the first worm wheel 114 and the worm 116 that is attached to the output shaft of the first motor 110. The above-described second power transmission mechanism 113a is constituted by the first worm wheel 114 and the worm 118a that is attached to the output shaft of the second motor 112a. Further, the above-described second power transmission mechanisms 113b, 113c are constituted respectively by the second worm wheel 115 and the worms 118b, 118c that are attached to the output shafts of the second motors 112b, 112c.

The first motor 110 and the second motors 112a to 112c are constituted as servomotors, in which rotational angle information and angular position (phase) information of the outer guide 40, which are detected by a sensor 59 (see FIG. 2) arranged in the vicinity of the outer guide 40, are input to a servo controller 61 (see FIG. 2), whereby the first motor 110 and the second motors 112a to 112c are subjected to feedback controls by the servo controller 61 based on the rotational angle information and the angular position information.

In the fifth embodiment, the backlash of the second power transmission mechanisms 99a to 99c is set to be greater than the backlash of the first power transmission mechanism 97, whereas in contradistinction thereto, in the sixth embodiment, the backlash of the first power transmission mechanism 111 is set substantially equivalent to the backlash of the second power transmission mechanisms 113a to 113c. That is, the mechanical backlash of the first power transmission mechanism 111 is substantially equivalent to the mechanical backlash of the second power transmission mechanisms 113a to 113c.

On the other hand, in the sixth embodiment, the inherent stop positioning accuracy of the second motors 112a to 112c is lower than the inherent stop positioning accuracy of the first motor 110. As a result, the actual stop positioning accuracy of the rotary stacking-receiving die assembly 32 by the second motors 112a to 112c is lower than the actual stop positioning accuracy of the rotary stacking-receiving die assembly 32 by the first motor 110. Preferably, the stop positioning accuracy of the second motors 112a to 112c is two times or more inferior than the stop positioning accuracy of the first motor 110. Stated otherwise, preferably, for the second motors 112a to 112c, ones are used in which the stop positioning accuracy thereof is two times or more dropped below that of the first motor 110.

The stacking apparatus 30e equipped with the driving device 10e according to the sixth embodiment is capable of manufacturing the ring core 12 by means of the same processing steps performed by the above-described stacking apparatus 30.

In accordance with the driving device 10e according to the sixth embodiment, when the rotary stacking-receiving die assembly 32 is driven, in addition to rotary driving of the rotary stacking-receiving die assembly 32 by the first motor 110, because rotation of the rotary stacking-receiving die assembly 32 is supplemented also by the second motors 112a to 112c, similar to the driving device 10 according to the first embodiment, compared to a case of driving by means of a single motor alone, the driving speed of the rotary stacking-receiving die assembly 32 can be improved, and a heavier workpiece can be handled.

Further, as stated previously, with the driving device 10e, by setting the inherent stop positioning accuracy of the second motors 112a to 112c to be lower than the inherent stop positioning accuracy of the first motor 110, because the stop positioning accuracy of the rotary stacking-receiving die assembly 32 by the second motors 112a to 112c is set lower than the stop positioning accuracy of the rotary stacking-receiving die assembly 32 by the first motor 110, even though the rotary stacking-receiving die assembly 32 is driven by a plurality of drive sources, the stop positioning controls among the drive sources themselves do not interfere with each other, and positioning of the rotary stacking-receiving die assembly 32 can be carried out with high precision.

With the driving device 10e, structures are adopted that have substantially equivalent mechanical backlashes in both the power transmission path between the first motor 110 and the rotary stacking-receiving die assembly 32 and the power transmission path between the second motors 112a to 112c and the rotary stacking-receiving die assembly 32. Even in this case, by making use of differences in the inherent stop positioning accuracies of the first motor 110 and the second motors 112a to 112c, the stop positioning accuracy of the rotary stacking-receiving die assembly 32 by the second motors 112a to 112c can easily be set lower than the stop positioning accuracy of the rotary stacking-receiving die assembly 32 by the first motor 110.

Further, in the sixth embodiment, concerning respective structural elements thereof which are common with the first and fifth embodiments, it is a matter of course that the same or similar operations and effects can be obtained as the operations and effects possessed by each of such common structural elements in the first and fifth embodiments.

The present invention is not limited to the above-described embodiments, and it is a matter of course that various other structures and processes could be adopted therein without deviating from the essential gist and scope of the present invention.

For example, in the first through fourth embodiments, although a case has been explained in which the first motors 60, 76, 80, 90 are constituted as direct drive motors, mechanisms may be adopted therefor in which the rotary force from the first motors 60, 76, 80, 90 is transmitted to the rotary stacking-receiving die assembly 32 via a belt mechanism.

In the first embodiment, a case has been explained in which the gear mechanisms 68, 69 are constituted as worm gears. However, the gear mechanisms 68, 69 may also be constituted by different types of gear mechanisms (e.g., spur gears, bevel gears, etc.).

In the second through fourth embodiments, a case has been explained in which the second motors 78, 82, 92 are constituted as direct drive motors. However, mechanisms may be adopted therefor in which the rotary force from the second motors 78, 82, 92 is transmitted to the rotary stacking-receiving die assembly 32 via a belt mechanism.

In the fifth and sixth embodiments, a case has been explained in which the first power transmission mechanisms 97, 111 and the second power transmission mechanisms 99a to 99c, 113a to 113c are constituted as worm gears. However, the first and second power transmission mechanisms may also be constituted by different types of gear mechanisms (e.g., spur gears, bevel gears, etc.).

In the third and fourth embodiments, a case has been explained in which splines and couplings are provided, respectively, as structures for providing mechanical backlash in the power transmission path between the second motors 82, 92 and the rotary stacking-receiving die assembly 32. However, other structures, which similarly have mechanical backlash, may be adopted.

In each of the above-described embodiments, as structural examples of a rotary mechanism for a machine tool according to the present invention, explanations have been made concerning driving devices 10, 10a to 10e for a rotary stacking-receiving die assembly, which is used for the purpose of stacking separate core plates 14. However, the present invention is not limited to such a range of applications, and is capable of being applied to other rotary mechanisms utilized for stacking non-separate ring-shaped core plates while the core plates are being rotated. More specifically, with the aim of eliminating or reducing plate thickness errors, the present invention can be applied to a rotary mechanism for rotatably driving a workpiece support that supports (retains) core plates, in apparatus in which ring-shaped core plates are stacked while the core plates are shifted in phase relatively between the core plates in the circumferential direction. In cases where the present invention is applied to such rotary mechanisms as well, similar to each of the above-described embodiments, effects can be obtained whereby the driving speed of the workpiece support can be improved, and a heavier workpiece can be handled.

Further, the present invention is capable of being applied to driving devices for rotatably driving a turntable of a machine tool, such as disclosed, for example, in International Publication No. WO 2007/102435. In this case, the turntable corresponds to the “workpiece support” in the present invention. Apart therefrom, the workpiece support is a concept that broadly includes rotary bodies on which workpieces are retained and rotatably driven, and it is a matter of course that the present invention can also be applied to mechanisms utilized for rotatably driving such types of workpiece supports.

What is claimed is:

1. A rotary mechanism for a machine tool having a workpiece support that is driven rotatably, comprising:
a first motor and a second motor for rotatably driving the workpiece support,
wherein a stop positioning accuracy of the workpiece support due to the second motor is lower than a stop positioning accuracy of the workpiece support due to the first motor.

2. The rotary mechanism for a machine tool according to claim 1,
wherein a driving force of the first motor is transmitted to the workpiece support substantially without mechanical backlash, and
wherein a predetermined amount of mechanical backlash is provided in a power transmission path between the second motor and the workpiece support.

3. The rotary mechanism for a machine tool according to claim 2,
wherein a rotor of the first motor is fixed to the workpiece support without mechanical backlash, and
wherein a gear mechanism is disposed in the power transmission path between the second motor and the workpiece support.

4. The rotary mechanism for a machine tool according to claim 2,
wherein a rotor of the first motor is fixed to the workpiece support without mechanical backlash, and
wherein a rotor of the second motor is fixed to the workpiece support through a spline and/or a coupling.

5. The rotary mechanism for a machine tool according to claim 1,
wherein driving forces of the first motor and the second motor are transmitted to the workpiece support substantially without mechanical backlash, and
wherein a stop positioning accuracy of the second motor is lower than a stop positioning accuracy of the first motor.

6. The rotary mechanism for a machine tool according to claim 1,
wherein a first power transmission mechanism having mechanical backlash is disposed in a power transmission path between the first motor and the workpiece support,
wherein a second power transmission mechanism having mechanical backlash is disposed in a power transmission path between the second motor and the workpiece support, and
wherein the mechanical backlash of the second power transmission mechanism is greater than the mechanical backlash of the first power transmission mechanism.

7. The rotary mechanism for a machine tool according to claim 1,
wherein a first power transmission mechanism having mechanical backlash is disposed in a power transmission path between the first motor and the workpiece support,
wherein a second power transmission mechanism having mechanical backlash is disposed in a power transmission path between the second motor and the workpiece support, and
wherein a stop positioning accuracy of the second motor is lower than a stop positioning accuracy of the first motor.

8. The rotary mechanism for a machine tool according to claim 1, wherein the second motor comprises a plurality of second motors.
